(19) United States
(12) Patent Application Publication
(10) Pub. No.: US 2023/0137374 A1
(43) Pub. Date: May 4, 2023

(54) ELECTRONIC DEVICE

(71) Applicant: Innolux Corporation, Miaoli County (TW)

(72) Inventors: Ming-Feng Hsieh, Miaoli County (TW); Yu-Tse Lu, Miaoli County (TW); Yu-Hsin Feng, Miaoli County (TW); Hsiao-Lan Su, Miaoli County (TW); Huang-Chi Chao, Miaoli County (TW)

(73) Assignee: Innolux Corporation, Miaoli County (TW)

(21) Appl. No.: 17/960,153

(22) Filed: Oct. 5, 2022

Related U.S. Application Data
(60) Provisional application No. 63/274,013, filed on Nov. 1, 2021.

(30) Foreign Application Priority Data
Aug. 2, 2022 (CN) 202210923717.8

(51) Int. Cl. G09G 3/34; G09G 3/20; G09G 3/36

(52) U.S. Cl. CPC G09G 3/3406; G09G 3/2007; G09G 3/3685; G09G 3/3674; G09G 2320/0626

(57) ABSTRACT

An electronic device is provided. The electronic device includes a panel, a backlight module, a first circuit, and a second circuit. The backlight module and the panel are disposed correspondingly. The first circuit includes a system circuit module. The second circuit includes a panel timing controlling module and a backlight timing controlling module. The backlight timing controlling module receives a first signal transmitted from the system circuit module and provides a backlight controlling signal to the backlight module. The panel timing controlling module receives a second signal transmitted from the system circuit module and provides a panel controlling signal to the panel. Another electronic device is also provided, such that the first circuit includes the system circuit module and the backlight timing controlling module.

### CROSS-REFERENCE TO RELATED APPLICATION

This application claims the priority benefit of the U.S. application Ser. No. 63/274,013 filed on Nov. 1, 2021 and China application serial no. 202210923717.8 filed on Aug. 2, 2022. The entirety of each of the above-mentioned patent applications is hereby incorporated by reference herein and made a part of this specification.

### BACKGROUND

### Technical Field

The disclosure relates to an electronic device, and more particularly to an electronic device including a panel and a backlight module.

### Description of Related Art

The backlight module may be applied to displays to display images in cooperation with the panel of the display. In general, the backlight module and the panel are controlled by different control circuits. Specifically, a backlight timing controlling module used to control the backlight module and a panel timing controlling module used to control the panel may operate respectively according to the corresponding signal of the system circuit. However, the current backlight timing controlling module is disposed on a separate circuit board and is coupled to the system circuit and the backlight module through a specific circuit, resulting in a burden on the cost. On the other hand, since the backlight timing controlling module is disposed on an independent circuit board, the circuit design of local dimming is limited.

### SUMMARY

The disclosure related to an electronic device which integrates a backlight timing controlling module into other circuits to reduce cost and increase circuit design flexibility.

In an embodiment of the disclosure, the electronic device includes a panel, a backlight module, a first circuit, and a second circuit. The backlight module and the panel are disposed correspondingly. The first circuit includes a system circuit module. The second circuit is coupled to the first circuit, the panel and the backlight module. The second circuit includes a panel timing controlling module and a backlight timing controlling module. The backlight timing controlling module receives a first signal transmitted from the system circuit module, and provides a backlight controlling signal to the backlight module. The panel timing controlling module receives a second signal transmitted from the system circuit module, and provides a panel controlling signal to the panel.

In another embodiment of the disclosure, the electronic device of the disclosure includes a panel, a backlight module, a first circuit, and a second circuit. The backlight module and the panel are disposed correspondingly. The first circuit is coupled to the backlight module. The first circuit includes a system circuit module and a backlight timing controlling module. The second circuit is coupled between the panel and the first circuit. The second circuit includes a panel timing controlling module. The backlight timing controlling module receives a first signal transmitted from the system circuit module, and provides a backlight controlling signal to the backlight module. The panel timing controlling module receives a second signal transmitted from the system circuit module, and provides a panel controlling signal to the panel.

Based on the above, the electronic device of the disclosure integrates the backlight timing controlling module into the panel timing controlling module or the system circuit module to perform corresponding operations in an integrated circuit. In this way, extra independent configuration is omitted through the integrated configuration of the backlight timing controlling module, thereby reducing the cost and increasing the circuit design flexibility of the electronic device.

This disclosure may be understood by referring to the following detailed description in conjunction with the accompanying drawings. It should be noted that, in order to facilitate understanding and for the concision of the drawings, only a part of the display device is shown in the drawings in this disclosure, and the specific components in the drawings are not drawn according to actual scale. In addition, the number and size of each component in the figure are only exemplary and are not used to limit the scope of the disclosure.

### BRIEF DESCRIPTION OF THE DRAWINGS

FIG. 1 is a schematic block diagram of an electronic device according to an embodiment of the disclosure.

FIG. 2 is a schematic block diagram of an electronic device according to an embodiment of the disclosure.

FIG. 3 is a schematic block diagram of an electronic device according to an embodiment of the disclosure.

FIG. 4 is a schematic operation diagram of the electronic device of the embodiment of FIG. 1 of the disclosure.

FIG. 5 is a schematic block diagram of an electronic device according to another embodiment of the disclosure.

FIG. 6 is a schematic block diagram of an electronic device according to another embodiment of the disclosure.

FIG. 7 is a schematic block diagram of an electronic device according to another embodiment of the disclosure.

FIG. 8 is a schematic operation diagram of the electronic device of the embodiment of FIG. 5 of the disclosure.

### BRIEF DESCRIPTION OF THE DRAWINGS

In the description of the disclosure and the appended claims, certain terms will be used to refer to specific elements. Persons skilled in the art would understand that display device manufacturers may refer to the same elements under different names. This disclosure does not intend to distinguish between elements that have the same functions but different names. In the following description and claims, the words “having” and “including” are open-ended words and thus should be interpreted as meaning “including but not limited to.”

In some embodiments of the disclosure, regarding the words such as “coupled”, “interconnected”, etc. referring to bonding and connection, unless specifically defined, these words mean that two structures are in direct contact or two structures are not in direct contact, and other structures are provided to be disposed between the two structures. The word for joining and connecting may also include the case where both structures are movable or both structures are fixed. In addition, the word “coupled” may include any direct or indirect electrical connection means.

The terminologies such as “first”, “second”, etc. provided in the specification and the claims serve to modify devices and do not imply and represent any previous ordinal numbers of the devices, the order of certain device and another device, and the order of a manufacturing method. The use of these ordinal numbers merely serves to clearly distinguish one device with a certain name from another device with the same name. Different words may be used in the claims and the specifications, and thereby a first component in the specification may be a second component in the claims. It should be understood that the following embodiments may replace, reorganize, and mix the technical features in several different embodiments to complete other embodiments without departing from the spirit of the disclosure.

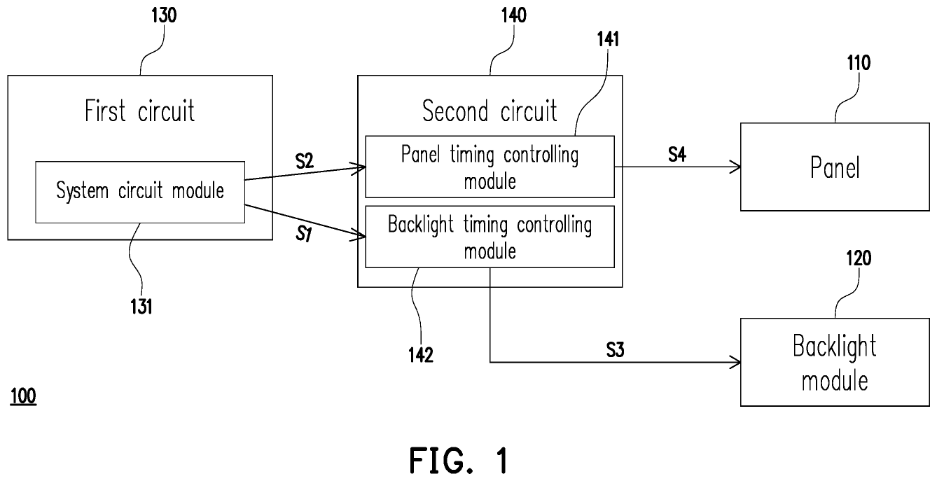

FIG. 1 is a schematic block diagram of an electronic device according to an embodiment of the disclosure. Referring to FIG. 1, the electronic device 100 includes, for example, an active matrix or a passive matrix display panel, but not limited thereto. In some embodiments, the electronic device 100 may include a display device, an antenna device, a sensing device, or a splicing device, but not limited thereto. The electronic device 100 may be a bendable or flexible electronic device. The electronic device 100 may include, for example, liquid crystals and light emitting diodes. The light emitting diode may include, for example, an organic light emitting diode (OLED), a mini LED, a micro LED, or a quantum dot light emitting diode (QD, such as QLED and QDLED), fluorescence, phosphor, or other suitable materials and their materials may be disposed and combined arbitrarily, but not limited thereto. The antenna device may be, for example, a liquid crystal antenna, but it is not limited thereto. The splicing device may be, for example, a display splicing device or an antenna splicing device, but not limited thereto. It should be noted that the electronic device 100 may be any combination of the foregoing, but it is not limited thereto. Hereinafter, the disclosure is described by taking the display device as the electronic device 100 or the splicing device, but the disclosure is not limited thereto.

In this embodiment, the electronic device 100 includes a panel 110, a backlight module 120, a first circuit 130, and a second circuit 140. The second circuit 140 is coupled to the first circuit 130, the panel 110, and the backlight module 120.

In this embodiment, the backlight module 120 and the panel 110 are disposed correspondingly. Specifically, in this embodiment, the backlight module 120 is parallel to the panel 110 and is disposed at a distance. In this embodiment, the panel 110 may be, for example, a liquid crystal panel. In this embodiment, the backlight module 120 may be, for example, a backlight plate using a cold cathode fluorescent lamp (CCFL) or a light-emitting diode (LED).

In this embodiment, the first circuit 130 includes a system circuit module 131. The system circuit module 131 instructs to generate a signal associated with the backlight module 120 by outputting a first signal S1. The system circuit module 131 instructs to generate a signal associated with the panel 110 by outputting a second signal S2. In this embodiment, the system circuit module 131 may be, for example, a system on chip (SoC) which may include microcontrollers, microprocessors, digital signal processors, and other processors, as well as memories read-only memory (ROM), random access memory (RAM), electronically erasable programmable read-only memory (EEPROM), flash memory, etc., that may run Windows, Linux, and other operating systems and other applications, but the disclosure is not limited thereto. In some embodiments, the system circuit module 131 may be a driving circuit that dispersedly disposing the microcontrollers and the microprocessors, etc.

In this embodiment, the second circuit 140 includes a panel timing controlling module 141 and a backlight timing controlling module 142. The backlight timing controlling module 142 is coupled between the system circuit module 131 and the backlight module 120. In this embodiment, the backlight timing controlling module 142 may generate a backlight controlling signal S3 associated with the backlight module 120 according to the first signal S1.

In this embodiment, the panel timing controlling module 141 is coupled between the system circuit module 131 and the panel 110. In this embodiment, the panel timing controlling module 141 may generate a panel controlling signal S4 associated with the panel 110 according to the second signal S2. In this embodiment, the second circuit 140 may be a timing controller (T-con), but not limited thereto.

In this embodiment, the backlight timing controlling module 142 receives a first signal S1 transmitted from the system circuit module 131, and provides the backlight controlling signal S3 to the backlight module 120. The panel timing controlling module 141 receives the second signal S2 transmitted from the system circuit module 131, and provides the panel controlling signal S4 to the panel 110. In other words, the backlight timing controlling module 142 and the panel timing controlling module 141 are integrated in the same second circuit 140. The backlight timing controlling module 142 and the panel timing controlling module 141 may respectively perform corresponding operations according to the signal S1 and the signal S2 from the system circuit module 131.

It should be noted that by integrating the backlight timing controlling module 142 and the panel timing controlling module 141 through the second circuit 140, it is possible to avoid disposing the backlight timing controlling module 142 in an additional separate circuit, thereby reducing the manufacturing cost. In addition, the integrated backlight timing controlling module 142 and the panel timing controlling module 141 may also receive the signals S1 and S2 from the system circuit module 131, respectively, thereby increasing the circuit design flexibility of the first circuit 130 and the integrated circuit (i.e., the second circuit 140).

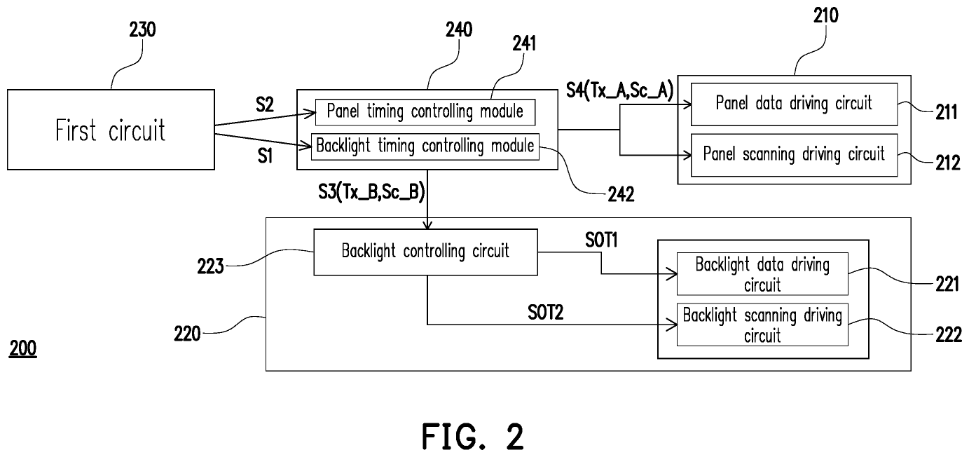

FIG. 2 is a schematic block diagram of an electronic device according to an embodiment of the disclosure. Referring to FIG. 2, the electronic device 200 includes a panel 210, a backlight module 220, a first circuit 230, and a second circuit 240. In the electronic device 200 of FIG. 2, the panel 210, the backlight module 220, the first circuit 230, the second circuit 240, and the panel timing controlling module 241 and the backlight timing controlling module 242 of the second circuit 240 may be deduced by analogy from the descriptions related to the electronic device 100 and thus are not repeated hereinafter.

In this embodiment, the panel 210 includes a panel data driving circuit 211 and a panel scanning driving circuit 212. The panel data driving circuit 211 and the panel scanning driving circuit 212 are respectively coupled to the panel timing controlling module 241. In addition, the panel 210 may include at least one display unit (not shown). According to the design requirements, in this embodiment, there may be multiple display units, and the number and arrangement of the display units may be determined according to actual requirements. According to practical applications, the display unit may include a pixel in a display panel in the form of liquid crystal, electrowetting, etc., but the disclosure is not limited thereto.

In this embodiment, the panel data driving circuit 211 and the panel scanning driving circuit 212 may receive the panel controlling signal S4 output by the panel timing controlling module 241 to drive the display unit. Specifically, in this embodiment, the panel data driving circuit 211 receives a data driving signal Tx_A in the panel controlling signal S4 to generate a data signal to be provided to the display unit. The panel scanning driving circuit 212 generates a scanning signal according to the scanning driving signal Sc_A in the panel controlling signal S4 to control whether the display unit receives the data signal from the panel data driving circuit 211. The display unit changes the transmittance thereof according to the data signal.

In this embodiment, the panel scanning driving circuit 212 may be, for example, a gate driver, and the panel data driving circuit 211 may be, for example, a source driver. In some embodiments, the panel data driving circuit 211 and/or the panel scanning driving circuit 212 may include, for example, graphic process units (GPU), or other programmable general-purpose or special-purpose microprocessors, digital signal processors (DSP), programmable controllers, application specific integrated circuits (ASIC), programmable logic devices (PLD), other similar processing devices or a combination of the foregoing.

In this embodiment, the backlight module 220 may be an active matrix backlight module, but not limited thereto. The backlight module 220 includes a backlight data driving circuit 221 and a backlight scanning driving circuit 222. The backlight data driving circuit 221 and the backlight scanning driving circuit 222 are respectively coupled to a backlight controlling circuit 223. In addition, the backlight module 220 may include at least one light emitting unit (not shown). According to the design requirements, in this embodiment, there are multiple light emitting units, and the number and arrangement of the display units may be determined according to actual requirements. According to practical applications, the light emitting unit may include cold cathode fluorescent lamp (CCFL), light emitting diode (LED), or other types of light emitting components, and this embodiment is not limited thereto. The light emitting diode may be, for example, a micro-LED, an organic light emitting diode (OLED), an inorganic light emitting diode (ILED), a mini-LED, a micro-LED, an electroluminescence (EL), and laser diode, etc.

In the embodiment of FIG. 2, the backlight controlling circuit 223 is coupled to the backlight data driving circuit 221, the backlight scanning driving circuit 222, and the backlight timing controlling module 242.

In this embodiment, the backlight data driving circuit 221 and the backlight scanning driving circuit 222 may drive the light emitting unit according to the backlight controlling signal S3 output by the backlight timing controlling module 242. Specifically, in this embodiment, the backlight controlling circuit 223 may output a backlight data driving signal SOT1 and a backlight scanning driving signal SOT2 according to the backlight controlling signal S3. The backlight data driving circuit 221 and the backlight scanning driving circuit 222 drives the light emitting unit according to the backlight data driving signal SOT1 and the backlight scanning driving signal SOT2.

In this embodiment, the backlight scanning driving circuit 222 may be, for example, a gate driver, and the backlight data driving circuit 221 may be, for example, a source driver. In some embodiments, the backlight data driving circuit 221, the backlight scanning driving circuit 222, and/or the backlight controlling circuit 223 may include, for example, graphic process units (GPU), or other programmable general-purpose or special-purpose microprocessors, digital signal processors (DSP), programmable controllers, application specific integrated circuits (ASIC), programmable logic devices (PLD), other similar processing devices or a combination of the foregoing.

Specifically, in this embodiment, The backlight controlling circuit 223 may convert the gray scale signal Tx_B of the backlight controlling signal S3 into the backlight data driving signal SOT1, so that the backlight data driving circuit 221 may generate a backlight data signal according to the backlight data driving signal SOT1. Similarly, the backlight controlling circuit 223 may convert the scanning signal Sc_B of the backlight controlling signal S3 into the backlight scanning driving signal SOT2, so that the backlight scanning driving circuit 222 may generate a backlight scanning signal according to the backlight scanning driving signal SOT2 to control whether the light emitting unit receives backlight data signal. The light emitting unit changes the brightness thereof according to the backlight data signal received. By controlling the brightness of the light emitting unit and the transmittance of the display unit, effects such as local dimming is achieved, or the quality of the image displayed by the electronic device 200 is improved.

It should be noted that, in this embodiment, the backlight controlling circuit 223 is disposed in the backlight module 220 instead of the second circuit 240 to save extra circuit configuration. For example, in this embodiment, the backlight controlling circuit 223 may be implemented by, for example, a driving board. The backlight module 220 may be implemented by, for example, a backlight plate. The driving board may be disposed on the backlight plate to couple to the light emitting unit, the backlight data driving circuit 221, and the backlight scanning driving circuit 222 on the backlight plate.

In this embodiment, the backlight controlling signal S3 includes the gray scale signal Tx_B and the scanning signal Sc_B. In this embodiment, the gray scale signal Tx_B may be, for example, low-voltage differential signaling (LVDS) or mini-LVDS, and is related to the brightness of the backlight display. In this embodiment, the scanning signal Sc_B is related to the timing of controlling the backlight display.

In this embodiment, each module on the second circuit 240 is disposed on the same circuit board. According to the design requirements, in this embodiment, the panel timing controlling module 241 and the backlight timing controlling module 242 in the second circuit 240 may be disposed on the same chip. That is, the panel timing controlling module 241 and the backlight timing controlling module 242 are integrated on the same chip and disposed on the same circuit board to reduce the manufacturing cost.

In some embodiments, according to the design requirements, the panel timing controlling module 241 and the backlight timing controlling module 242 in the second circuit 240 may be disposed on different chips. That is, the panel timing controlling module 241 and the backlight timing controlling module 242 are disposed on different chips respectively on the same circuit board to reduce the manufacturing cost.

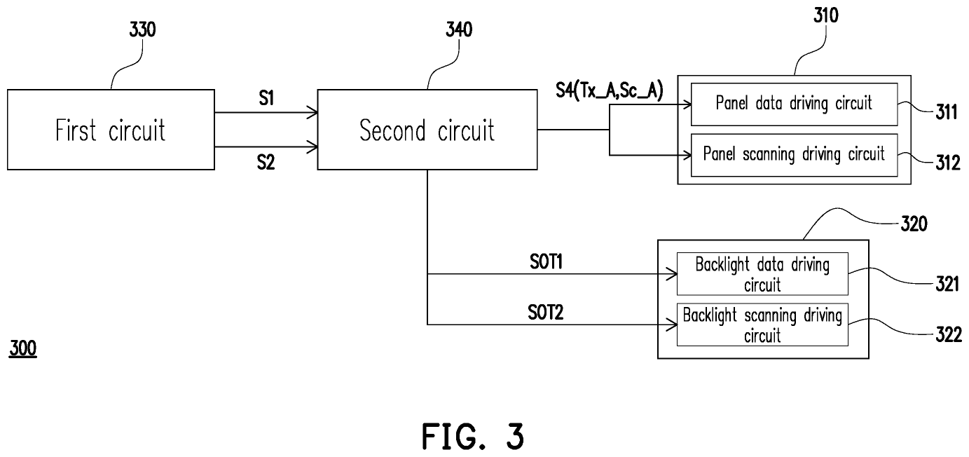

FIG. 3 is a schematic block diagram of an electronic device according to an embodiment of the disclosure. Referring to FIG. 3, the electronic device 300 includes a panel 310, a backlight module 320, a first circuit 330, and a second circuit 340. In the electronic device 300 of FIG. 3, the panel 310, the backlight module 320, the first circuit 330, the second circuit 340, the panel data driving circuit 311 and the panel scanning driving circuit 312 of the panel 310, and the backlight data driving circuit 321 and the backlight scanning driving circuit 322 of the backlight module 320 may be deduced by analogy from the descriptions related to the electronic device 100 and/or the electronic device 200 and thus are not repeated hereinafter.

In the embodiment of FIG. 3, the electronic device 300 further includes a backlight controlling circuit. The backlight controlling circuit is coupled to the backlight data driving circuit 321 and the backlight scanning driving circuit 322. The backlight controlling circuit may be deduced by analogy from the descriptions related to the backlight controlling circuit 223 of the electronic device 200 and thus is not repeated hereinafter. Different from the embodiment of FIG. 2, in this embodiment, the backlight controlling circuit may be integrated in the second circuit 340 instead of the backlight module 320, so the backlight controlling circuit is not shown in FIG. 3.

It should be noted that, in this embodiment, Since the backlight controlling circuit and the backlight timing controlling module (e.g., the backlight timing controlling module 242 of FIG. 2) are both disposed in the second circuit 340 instead of the backlight module 320, the backlight controlling circuit may generate a backlight data driving signal SOT1 and a backlight scanning driving signal SOT2 in the second circuit 340 according to the signal output by the backlight timing controlling module. In this embodiment, the backlight controlling signal output by the second circuit 340 includes the backlight data driving signal SOT1 and the backlight scanning driving signal SOT2 instead of the gray scale signal (e.g., the gray scale signal Tx_B of FIG. 2) and the scanning signal (e.g., the scanning signal Sc_B of FIG. 2). Therefore, the backlight data driving circuit 321 and the backlight scanning driving circuit 322 receive the backlight controlling signal (i.e., signal SOT1 and signal SOT2) to perform corresponding operations.

In this embodiment, the backlight controlling circuit and the second circuit 340 may be disposed on the same circuit board. According to the design requirements, in this embodiment, at least two of the panel timing controlling module, the backlight timing controlling module, and the backlight controlling circuit in the second circuit 340 may be disposed on the same chip. That is, the panel timing controlling module and the backlight timing controlling module, the panel timing controlling module and the backlight controlling circuit, or the backlight timing controlling module and the backlight controlling circuit may be integrated on the same chip and on the same circuit board to reduce the manufacturing cost.

In some embodiments, according to the design requirements, at least two of the panel timing controlling module, the backlight timing controlling module, and the backlight controlling circuit in the second circuit 340 may be disposed on different chips. That is, the panel timing controlling module, the backlight timing controlling module, and the backlight controlling circuit are disposed on different chips respectively, but may still be disposed on the same circuit board to reduce the manufacturing cost.

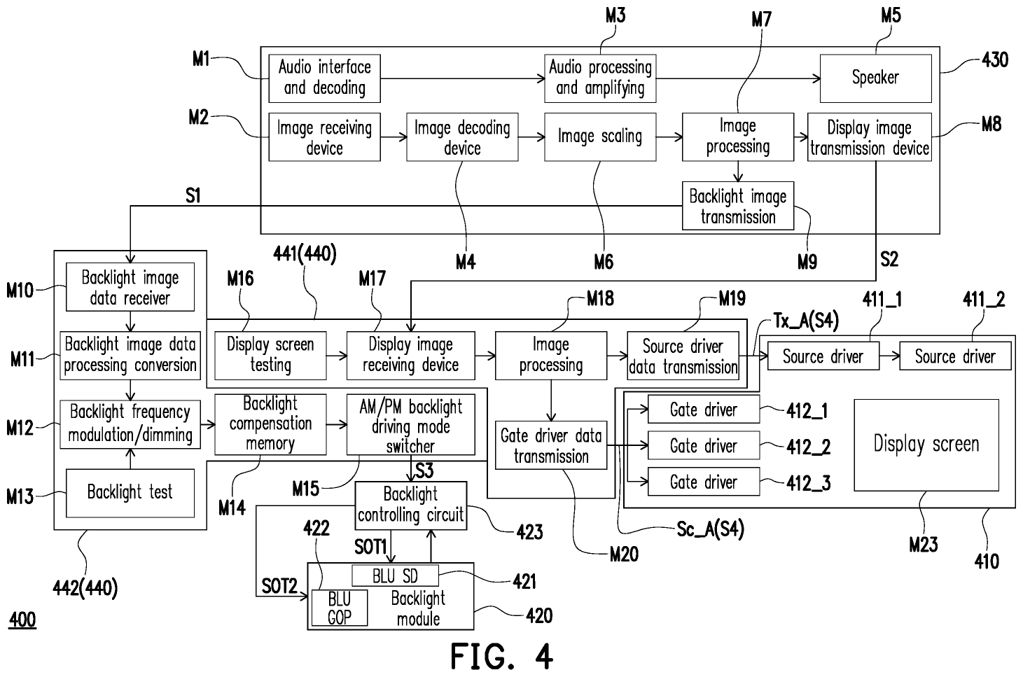

FIG. 4 is a schematic operation diagram of the electronic device of the embodiment of FIG. 1 of the disclosure. Referring to FIG. 4, the electronic device 400 includes a panel 410, a backlight module 420, a first circuit 430, a second circuit 440, and a backlight controlling circuit 423. In the electronic device 400 of FIG. 4, the panel 410, the backlight module 420, the first circuit 430, the second circuit 440, the backlight data driving circuit 421 and the backlight scanning driving circuit 422 of the backlight module 420, the panel timing controlling module 441 and the backlight timing controlling module 442 of the second circuit 440, and the backlight controlling circuit 423 may be deduced by analogy from the descriptions related to the electronic device 100, the electronic device 200, and/or the electronic device 300 and thus are not repeated hereinafter.

In the embodiment of FIG. 4, the first circuit 430 may include a single chip and be disposed in the first circuit board. The second circuit 440 may include a single chip or multiple chips and be disposed in the second circuit board instead of the first circuit board. The panel 410 may be a display panel. The backlight module 420 may be a backlight plate. In this embodiment, the backlight controlling circuit 423 may be a single chip and be disposed in the backlight module 420. In some embodiments, the backlight controlling circuit 423 may be integrated in one of the chips of the second circuit 440, and be disposed in the second circuit board with the second circuit 440. The configuration of each circuit and each module on the different circuit boards, display panels, and backlight plates in this embodiment are only examples, and not limited thereto.

In this embodiment, the system circuit module of the first circuit 430 may include multiple functional modules M1 to M9, and perform corresponding operations to output audio, the first signal S1, and the second signal S2. Specifically, the first circuit 430 may include an audio interface and decoding module M1, an image receiving device module M2, an audio processing and amplifying module M3, an image decoding device module M4, a speaker module M5, an image scaling module M6, an image processing module M7, a display image transmission device module M8, and a backlight image transmission module M9, but the types of modules that may be included in the first circuit 430 are not limited thereto.

In this embodiment, the audio interface and decoding module M1 is coupled to the audio processing and amplifying module M3. The audio processing and amplifying module M3 is coupled to the speaker module M5. In this embodiment, the audio interface and decoding module M1, the audio processing and amplifying module M3, and the speaker module M5, may control and process the information related to the audio transmitted in the electronic device 400.

Specifically, in this embodiment, the audio interface and decoding module M1 is configured to receive the user's audio data. The audio interface and decoding module M1 is configured to decode the received audio data into a standard format conforming to audio files to generate audio information. The audio processing and amplifying module M3 is configured to process the audio information output by the audio interface and decoding module M1, such as adjusting and amplifying. The speaker module M5 is configured to convert the processed audio information, such as converting electrical energy into sound energy or converting digital signals into analog signals to output audio.

In this embodiment, the image receiving device module M2 is coupled to the image decoding device module M4. The image decoding device module M4 is coupled to the image scaling module M6. The image scaling module M6 is coupled to the image processing module M7. The image processing module M7 is coupled to the display image transmission device module M8 and the backlight image transmission module M9. The display image transmission device module M8 is coupled to the panel timing controlling module 441. The backlight image transmission module M9 is coupled to the backlight timing controlling module 442. In this embodiment, the image receiving device module M2, the image decoding device module M4, the image scaling module M6, the image processing module M7, the display image transmission device module M8, and the backlight image transmission module M9 may control and process the information related to the image transmitted in the electronic device 400.

Specifically, in this embodiment, the image receiving device module M2 is configured to receive the user's image data. The image decoding device module M4 is configured to receive the image data output by the image receiving device module M2. The image decoding device module M4 is configure to perform analog-to-digital conversion on the image data to decode the analog image data into a digital signal format. The image scaling module M6 is configured to perform scaling processing on the decoded image data, such as converting the image data into a required image size. The image processing module M7 is configured to adjust the scaled image data according to a human interface device, such as adjusting the image configuration of the image data or converting the format of the image data. The display image transmission device module M8 is configured to use the adjusted image data as the display data of the panel 410 (i.e., the second signal S2), and transmit the second signal S2 to the panel timing controlling module 441 of the second circuit 440. In addition, the backlight image transmission module M9 is configured to use the adjusted image data as the light emitting data (i.e., the first signal S1) of the backlight module 420, and transmit the first signal S1 to the backlight timing controlling module 442 of the second circuit 440.

In this embodiment, the backlight timing controlling module 442 of the second circuit 440 may include multiple functional modules M10 to M15, and perform corresponding operations to output the backlight controlling signal S3 according to the first signal S1. Specifically, the backlight timing controlling module 442 may include, a backlight image data receiver module M10, a backlight image data processing conversion module M11, a backlight frequency modulation/dimming module M12, a backlight test module M13, a backlight compensation memory module M14, and an AM/PM (Active Matrix/Passive Matrix) backlight driving mode switcher module M15, but the functional modules that may be included in the backlight timing controlling module 442 are not limited thereto.

In this embodiment, the backlight image data receiver module M10 is coupled to the backlight image transmission module M9 and the backlight image data processing conversion module M11. The backlight image data processing conversion module M11 is coupled to the backlight frequency modulation/dimming module M12. The backlight frequency modulation/dimming module M12 is coupled to the backlight test module M13 and the backlight compensation memory module M14. The backlight compensation memory module M14 is coupled to the AM/PM backlight driving mode switcher module M15. In this embodiment, the modules M10 to M15 in the backlight timing controlling module 442 may process the information related to the light emitting data of the backlight module 420 transmitted in the electronic device 400.

Specifically, in this embodiment, the backlight image data receiver module M10 is configured to receive the first signal S1. The backlight image data processing conversion module M11 is configured to receive the light emitting data (i.e., the first signal S1) output by the backlight image data receiver module M10. The backlight image data processing conversion module M11 is configured to perform image processing on the light emitting data, such as spatially expanding or reducing the light emitting data. In some cases, the backlight test module M13 is configured to perform a test operation, such as an aging test operation. The backlight test module M13 is configured to test and correct the brightness of the light board, thereby ensuring that the brightness function of the light board of the backlight module 420 functions properly.

Moreover, in this embodiment, the backlight frequency modulation/dimming module M12 is configured to receive the data output by the backlight image data processing conversion module M11 and/or the test data output by the backlight test module M13. The backlight frequency modulation/dimming module M12 is configured to dim the received data, thereby adjusting the brightness of the light emitting data. The backlight frequency modulation/dimming module M12 is also configured to modulate the received data, thereby converting the light emitting data into different frequencies according to the user's needs and the backlight brightness information, such as converting the frequency of the light emitting data from 60 Hz to 120 Hz. The backlight compensation memory module M14 is configured to compensate the modulated and/or dimmed light emitting data, such as compensating the backlight uniformity of the backlight image data. The AM/PM (Active Matrix/Passive Matrix) backlight driving mode switcher module M15 is configured to switch between two or more backlight controlling modes to support the active matrix backlight module 420 and the passive matrix backlight module 420. The AM/PM (Active Matrix/Passive Matrix) backlight driving mode switcher module M15 is configured to provide compensated light emitting data (i.e., backlight controlling signal S3) according to the switched backlight controlling mode.

In this embodiment, the backlight controlling circuit 423 may generate the backlight data driving signal SOT1 and the backlight scanning driving signal SOT2 according to the backlight controlling signal S3. The backlight scanning driving circuit 422 may drive the light emitting unit according to the backlight scanning driving signal SOT2. The backlight data driving circuit 421 may control the brightness of the light emitting unit according to the backlight data driving signal SOT1. In this embodiment, the backlight data driving circuit 421 may feedback the light emitting result to the backlight controlling circuit 423, but not limited thereto.

In this embodiment, the panel timing controlling module 441 of the second circuit 440 may include multiple functional modules M16 to M20, and perform corresponding operations to output the panel controlling signal S4 according to the second signal S2. Specifically, the panel timing controlling module 441 includes a display screen testing module M16, a display image receiving device module M17, an image processing module M18, a source driver data transmission module M19, and a gate driver data transmission module M20, but the functional modules that may be included in the panel timing controlling module 441 are not limited thereto.

In this embodiment, the display screen testing module M16 is coupled to the display image receiving device module M17. The display image receiving device module M17 is coupled to the display image transmission device module M8 and the image processing module M18. The image processing module M18 is coupled to the source driver data transmission module M19 and the gate driver data transmission module M20. The source driver data transmission module M19 is coupled to the panel 410. In this embodiment, the modules M16 to M20 in the panel timing controlling module 441 may process the information related to the display data of the panel 410 transmitted in the electronic device 400.

Specifically, in this embodiment, in some cases, the display screen testing module M16 is configured to perform a test operation, such as an aging test operation. The display screen testing module M16 is configured to generate test image data of the panel 410, thereby ensuring that the display function of the panel 410 functions properly. The display image receiving device module M17 is configured to receive the display data (i.e., the second signal S2) output by the display image transmission device module M8 and/or the test data output by the display screen testing module M16. The image processing module M18 is configured to receive the data output by the display image receiving device module M17. The image processing module M18 is configured to perform processing on the display data, for example, reinforcement and enhancement operations such as demura and/or dithering. The source driver data transmission module M19 is configured to receive the data output by the image processing module M18. The source driver data transmission module M19 is configured to transmit the data driving signal Tx_A of the panel controlling signal S4 to the panel 410. The gate driver data transmission module M20 is configured to receive the data output by the image processing module M18. The gate driver data transmission module M20 is configured to transmit the scanning driving signal Sc_A of the panel controlling signal S4 to the panel 410.

In this embodiment, the functional modules M1 to M20 may be ports, receivers, speakers, central processing units (CPU), or other programmable general-purpose or special-purpose microprocessors, digital signal processors (DSP), programmable controllers, application specific integrated circuits (ASIC), programmable logic devices (PLD), other similar devices or a combination of the foregoing which may load and execute computer program-related firmware or software to implement the corresponding operation functions.

In this embodiment, the panel 410 may include a panel data driving circuit 411 and a panel scanning driving circuit 412. The panel data driving circuit 411 may include multiple source drivers 411_1 and 411_2. The panel scanning driving circuit 412 may include multiple gate drivers 412_1 to 412_3 and a display screen M23 including multiple display units. The quantity and configuration of the source drivers 411_1 and 411_2 and gate drivers 412_1 to 412_3 of this embodiment are only examples, and not limited thereto.

In this embodiment, the source drivers 411_1 and 411_2 may be, but not limited to, serially coupled. Specifically, the source driver 411_1 is coupled to the source driver data transmission module M19, the source driver 411_2, and the display screen M23. The source driver 411_2 is coupled to the display screen M23. In this embodiment, the source driver 411_1 may drive the display units in the display screen M23 according to the data driving signal Tx_A of the panel controlling signal S4, thereby changing the transmittance of the display unit according to the data driving signal Tx_A. The source driver 411_2 may be deduced by analogy from the descriptions related to the source driver 411_1 and thus is not repeated hereinafter.

In this embodiment, the gate drivers 412_1 to 412_3 may be, but not limited to, coupled in parallel. Specifically, the gate driver 412_1 is coupled to the gate driver data transmission module M20 and the display screen M23. The gate driver 412_1 may drive the display units in the display screen M23 according to the scanning driving signal Sc_A of the panel controlling signal S4. In this embodiment, the gate driver 412_2 and the gate driver 412_3 may be deduced by analogy from the descriptions related to the gate driver 412_1 and thus are not repeated hereinafter.

In this embodiment, the first signal S1 may be, for example, a signal conforming to the serial peripheral interface bus (SPI) specification. In some embodiments, the first signal S1 may be transmitted to the backlight timing controlling module 442 through an inter-integrated circuit (I²C), but this embodiment is not limited thereto. In this embodiment, the second signal S2 may be, for example, a signal conforming to the V-by-One (V*1) specification. In some embodiments, the second signal S2 may be transmitted to the panel timing controlling module 441 through a V-by-One cable, but this embodiment is not limited thereto.

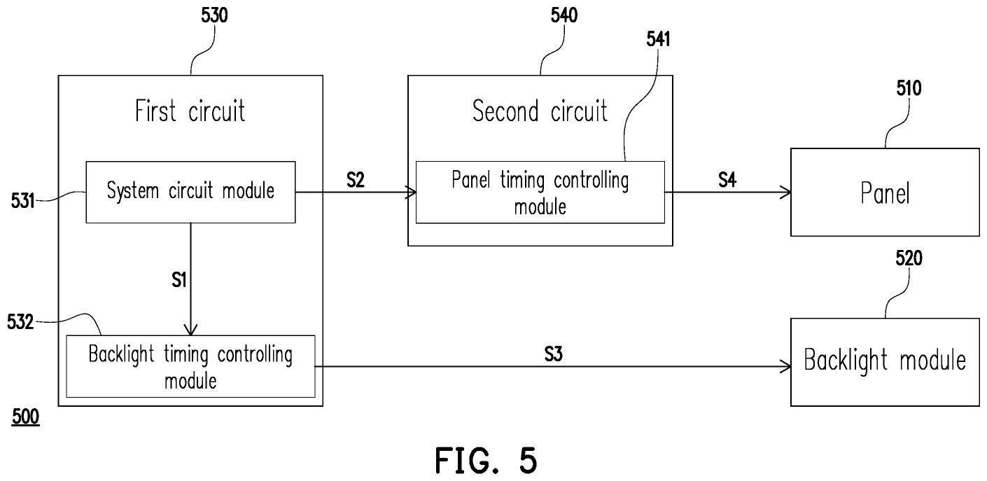

FIG. 5 is a schematic block diagram of an electronic device according to another embodiment of the disclosure. The type of the electronic device 500 in FIG. 5 may be the same as the type of the electronic device in FIG. 1 and thus is not repeated hereinafter. The disclosure is described below by taking the display device as the electronic device 500 or the splicing device, but the disclosure is not limited thereto.

In this embodiment, the electronic device 500 includes a panel 510, a backlight module 520, a first circuit 530, and a second circuit 540. The first circuit 530 is coupled to the backlight module 520. The second circuit 540 is coupled between the panel 510 and the first circuit 530.

In this embodiment, the disposition of the backlight module 520 and the panel 510 may be similar to the backlight module 120 and the panel 110 in the embodiment shown in FIG. 1 and thus is not repeated hereinafter.

In this embodiment, the first circuit 530 includes a system circuit module 531 and a backlight timing controlling module 532. The second circuit 540 includes a panel timing controlling module 541. The panel timing controlling module 541 is coupled between the system circuit module 531 and the panel 510. The system circuit module 531 is coupled to the backlight timing controlling module 532. The system circuit module 531 instructs to generate a clock signal (i.e., backlight controlling signal S3) associated with the backlight module 520 by outputting a first signal S1 to the backlight timing controlling module 532. The panel timing controlling module 541 is coupled between the system circuit module 531 and the panel 510. In this embodiment, the system circuit module 531 may output the second signal S2 to the second circuit 540, and the panel timing controlling module 541 may generate a clock signal (i.e., the panel controlling signal S4) associated with the panel 510 according to the second signal S2. The type and function of the system circuit module 531, the backlight timing controlling module 532, and the panel timing controlling module 541 may be similar to the system circuit module 131, the backlight timing controlling module 142, and the panel timing controlling module 141 in the embodiment shown in FIG. 1 and thus are not repeated hereinafter.

In this embodiment, the backlight timing controlling module 532 receives a first signal S1 transmitted from the system circuit module 531 and provides a backlight controlling signal S3 to the backlight module 520. The panel timing controlling module 541 receives a second signal S2 transmitted from the system circuit module 531 and provides a panel controlling signal S4 to the panel 510. In other words, the backlight timing controlling module 532 and the system circuit module 531 are integrated in the same first circuit 530. The backlight timing controlling module 532 may receive the first signal S1 in the same circuit block to perform corresponding operations.

It should be noted that by integrating the backlight timing controlling module 532 and the system circuit module 531 through the first circuit 530, it is possible to avoid disposing the backlight timing controlling module 532 in an additional separate circuit, thereby reducing the manufacturing cost. In addition, the integrated backlight timing controlling module 532 and the system circuit module 531 may also transmit the first signal S1 in the same circuit block to reduce the circuit configuration between the two. At the same time, the circuit design flexibility of the second 540 and the integrated circuit (i.e., the first circuit 530) may be increased.

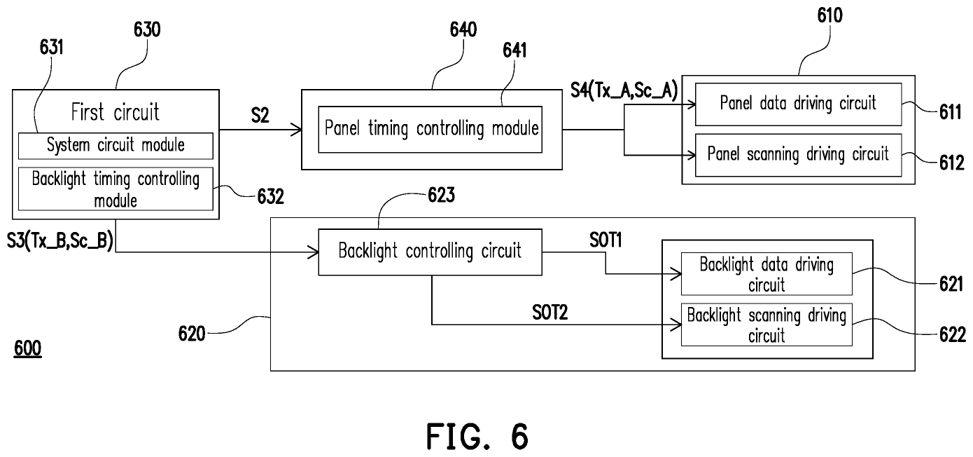

FIG. 6 is a schematic block diagram of an electronic device according to another embodiment of the disclosure. Referring to FIG. 6, the electronic device 600 includes a panel 610, a backlight module 620, a first circuit 630, and a second circuit 640. In the electronic device 600 in FIG. 6, the panel 610, the backlight module 620, the first circuit 630, the second circuit 640, the system circuit module 631 and the backlight timing controlling module 632 of the first circuit 630, and the panel timing controlling module 641 of the second circuit 640 may be deduced by analogy from the relevant descriptions in the preceding paragraphs and thus are not repeated hereinafter.

In this embodiment, the panel 610 includes a panel data driving circuit 611 and a panel scanning driving circuit 612. The panel data driving circuit 611 and the panel scanning driving circuit 612 of the embodiment of FIG. 6 may be deduced by analogy from the description related to the panel data driving circuit 211 and the panel scanning driving circuit 212 of the embodiment of FIG. 2 and thus are not repeated hereinafter.

In this embodiment, the backlight module 620 includes a backlight data driving circuit 621 and a backlight scanning driving circuit 622. In addition, the backlight controlling circuit 623 is disposed in the backlight module 620 instead of the first circuit 630 or the second circuit 640. The backlight data driving circuit 621 is coupled to the backlight scanning driving circuit 622. In this embodiment, the backlight data driving circuit 621, the backlight scanning driving circuit 622, and the backlight controlling circuit 623 may be deduced by analogy from the description related to the backlight data driving circuit 221, the backlight scanning driving circuit 222, and the backlight controlling circuit 223 of the embodiment of FIG. 2 and thus are not repeated hereinafter.

In this embodiment, the backlight controlling signal S3 includes the gray scale signal Tx_B and the scanning signal Sc_B. In this embodiment, the gray scale signal Tx_B may be, for example, low-voltage differential signaling (LVDS) or mini-LVDS, which indicates data related to the backlight display. In this embodiment, the scanning signal Sc_B is related to the timing of controlling the backlight display.

In this embodiment, the system circuit module 631 and the backlight timing controlling module 632 on the first circuit 630 are both disposed on the same circuit board. According to the design requirements, in this embodiment, the system circuit module 631 and the backlight timing controlling module 632 in the first circuit 630 may be disposed on the same chip. That is, the system circuit module 631 and the backlight timing controlling module 632 are integrated on the same chip and on the same circuit board to reduce the manufacturing cost.

In some embodiments, according to the design requirements, the system circuit module 631 and the backlight timing controlling module 632 in the first circuit 630 may be disposed on different chips. That is, the system circuit module 631 and the backlight timing controlling module 632 are disposed on different chips respectively, but still be disposed on the same circuit board to reduce the manufacturing cost.

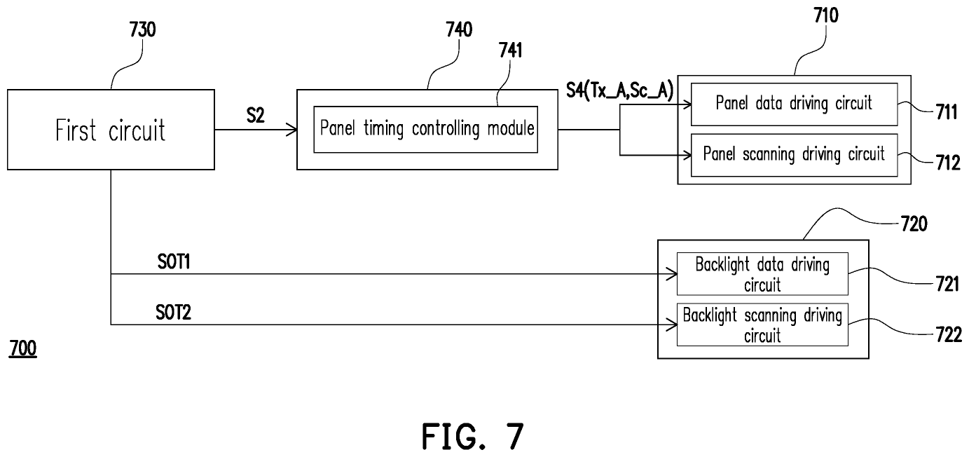

FIG. 7 is a schematic block diagram of an electronic device according to another embodiment of the disclosure. Referring to FIG. 7, the electronic device 700 includes a panel 710, a backlight module 720, a first circuit 730, and a second circuit 740. In the electronic device 700 of FIG. 7, the panel 710, the backlight module 720, the first circuit 730, the second circuit 740, the panel data driving circuit 711 and the panel scanning driving circuit 712 of the panel 710, and the backlight data driving circuit 721 and the backlight scanning driving circuit 722 of the backlight module 720 of may be deduced by analogy from the descriptions related to the electronic device 300, the electronic device 500, and/or electronic device 600 and thus are not repeated hereinafter.

In the embodiment of FIG. 7, the electronic device 700 further includes the backlight controlling circuit that is integrated in the first circuit 730, so the backlight controlling circuit is not shown in FIG. 7. The backlight controlling circuit is coupled to the backlight data driving circuit 721 and the backlight scanning driving circuit 722. The backlight controlling circuit may be deduced by analogy from the descriptions related to the backlight controlling circuit 623 of the electronic device 600 and thus is not repeated hereinafter.

It should be noted that, in this embodiment, since the backlight controlling circuit and the backlight timing controlling module (e.g., the backlight timing controlling module 632 of FIG. 6) are both disposed in the first circuit 730 instead of the backlight module 720, the backlight controlling circuit may generate a backlight data driving signal SOT1 and a backlight scanning driving signal SOT2 in the first circuit 730 according to the signal output by the backlight timing controlling module. In this embodiment, the backlight controlling signal output by the first circuit 730 includes the backlight data driving signal SOT1 and the backlight scanning driving signal SOT2 instead of the gray scale signal (e.g., the gray scale signal Tx_B of FIG. 6) and the scanning signal (e.g., the scanning signal Sc_B of FIG. 6). Therefore, the backlight data driving circuit 721 and the backlight scanning driving circuit 722 receive the backlight controlling signal (i.e., signal SOT1 and signal SOT2) to perform corresponding operations.

In this embodiment, the backlight controlling circuit and the first circuit 730 may be disposed on the same circuit board. According to the design requirements, in this embodiment, at least two of the system circuit modules, backlight timing controlling module, and the backlight controlling circuit in the first circuit 730 may be disposed on the same chip. That is, the system circuit module and the backlight timing controlling module, the system circuit module and the backlight controlling circuit, or the backlight timing controlling module and the backlight controlling circuit are integrated on the same chip and on the same circuit board to reduce the manufacturing cost.

In some embodiments, according to the design requirements, any two of the system circuit modules, the backlight timing controlling module, and the backlight controlling circuit in the first circuit 730 may be disposed on different chips. That is, the system circuit module and the backlight timing controlling module, the system circuit module and the backlight controlling circuit, or the backlight timing controlling module and the backlight controlling circuit are disposed on different chips respectively and on the same circuit board to reduce the manufacturing cost.

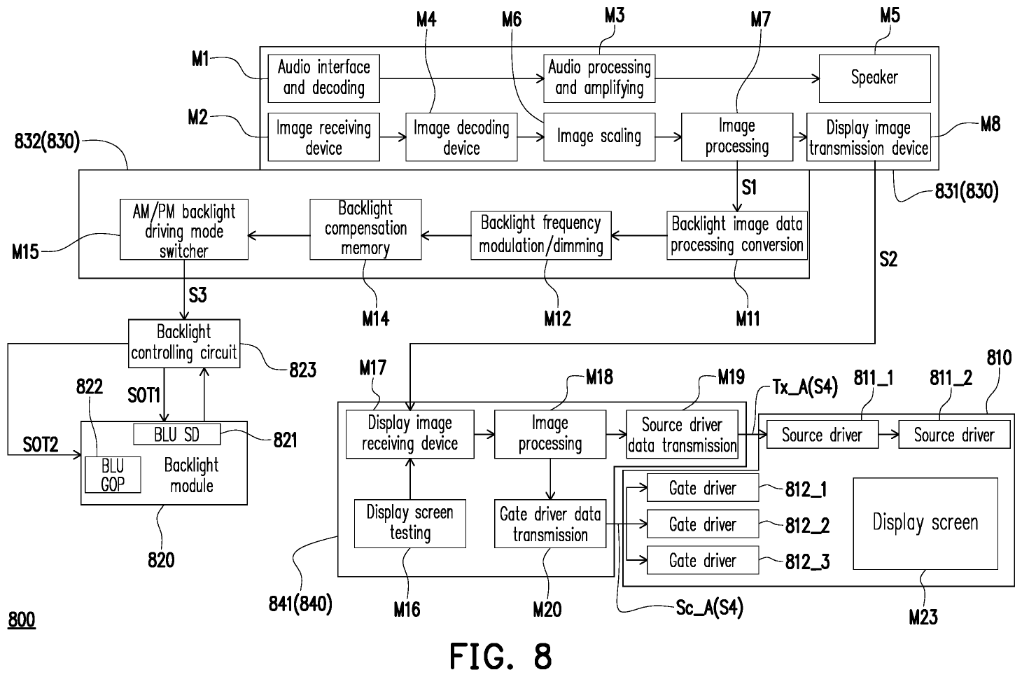

FIG. 8 is a schematic operation diagram of the electronic device of the embodiment of FIG. 5 of the disclosure. Referring to FIG. 8, the electronic device 800 includes a panel 810, a backlight module 820, a first circuit 830, and the panel timing controlling module 841 and backlight controlling circuit 823 in the second circuit 840. In the electronic device 800 of FIG. 8, the panel 810, the backlight module 820, the first circuit 830, the panel timing controlling module 841, the backlight data driving circuit 821 and the backlight driving circuit 822 of the backlight module 820, the system circuit module 831 and the backlight timing controlling module 832 of the first circuit 830, and the backlight controlling circuit 823 may be deduced by analogy from the descriptions related to the electronic device 500, electronic device 600, and/or electronic device 700 and thus are not repeated hereinafter.

In addition, in the embodiment of FIG. 8, the system circuit module 831 may include multiple functional modules M1 to M9, the backlight timing controlling module 832 may include multiple functional modules M11 to M15, the panel timing controlling module 841 may include multiple functional modules M16 to M20. The functions and execution sequences of the functional modules M1 to M20 in the embodiment of FIG. 8 may be similar to the embodiment shown in FIG. 4 and thus are not repeated hereinafter.

Similarly, in this embodiment, the configuration and function of the panel 810 and the backlight module 820 may be deduced by analogy from the descriptions related to the electronic device 400 and thus are not repeated hereinafter.

To sum up, the electronic device of the disclosure integrates the backlight timing controlling module, the panel timing controlling module, or the system circuit module to perform corresponding operations in an integrated circuit. In this way, extra independent configuration is omitted through the integrated configuration of the backlight timing controlling module, thereby reducing the cost and increasing the circuit design flexibility of the electronic device. In some embodiments, the backlight controlling circuit is integrated in the backlight module, the first circuit, or the second circuit to save extra circuit configuration. In some embodiments, the backlight timing controlling module, the panel timing controlling module, and the system circuit module are disposed on the same or different chips and are disposed on the corresponding circuit board to increase the circuit design flexibility and reduce the manufacturing cost of the electronic device.

Finally, it should be noted that the above embodiments are only used to illustrate the technical solutions of the disclosure and are not intended to limit it. Although the disclosure has been described in detail with reference to the above embodiments, persons of ordinary skill in the art should understand that they may still modify the technical solutions described in the above embodiments, or replace some or all of the technical features therein with equivalents, and that such modifications or replacements of corresponding technical solutions do not substantially deviate from the scope of the technical solutions of the embodiments of the disclosure.

What is claimed is:

1. An electronic device, comprising:
a panel;
a backlight module, disposed corresponding to the panel;
a first circuit, comprising a system circuit module; and
a second circuit, coupled to the first circuit, the panel, and the backlight module, and comprising a panel timing controlling module and a backlight timing controlling module,
wherein the backlight timing controlling module receives a first signal transmitted from the system circuit module and provides a backlight controlling signal to the backlight module, and the panel timing controlling module receives a second signal transmitted from the system circuit module and provides a panel controlling signal to the panel.

2. The electronic device according to claim 1, wherein the second circuit is disposed on a circuit board, wherein the panel timing controlling module and the backlight timing controlling module are disposed on different chips.

3. The electronic device according to claim 1, wherein the second circuit is disposed on a circuit board, wherein the panel timing controlling module and the backlight timing controlling module are disposed on a same chip.

4. The electronic device according to claim 1, wherein the backlight module comprises:
at least one light emitting unit;
a backlight data driving circuit; and
a backlight scanning driving circuit, wherein the backlight data driving circuit and the backlight scanning driving circuit drive the at least one light emitting unit according to the backlight controlling signal.

5. The electronic device according to claim 4, wherein the backlight module further comprises:
a backlight controlling circuit, coupled to the backlight timing controlling module, the backlight data driving circuit, and the backlight scanning driving circuit, outputting a backlight data driving signal to the backlight data driving circuit according to the backlight controlling signal, and outputting a backlight scanning driving signal to the backlight scanning driving circuit, wherein the backlight controlling signal comprises a gray scale signal and a scanning signal.

6. The electronic device according to claim 5, wherein the gray scale signal is related to a brightness of the at least one light emitting unit, and the scanning signal is related to a timing of the at least one light emitting unit.

7. The electronic device according to claim 4, further comprising:
a backlight controlling circuit, coupled to the backlight timing controlling module, the backlight data driving circuit, and the backlight scanning driving circuit, wherein the backlight controlling circuit and the second circuit are disposed on a same circuit board.

8. The electronic device according to claim 1, wherein the panel comprises:
at least one display unit;
a panel data driving circuit, coupled to the panel timing controlling module; and
a panel scanning driving circuit, coupled to the panel timing controlling module, wherein the panel data driving circuit and the panel scanning driving circuit drive the at least one display unit according to the panel controlling signal.

9. The electronic device according to claim 8, wherein the panel controlling signal comprises a data driving signal and a scanning driving signal.

10. The electronic device according to claim 9, wherein the panel data driving circuit generates a data signal to be provided to the at least one display unit according to the data driving signal, and the panel scanning driving circuit controls the at least one display unit to receive the data signal according to the scanning driving signal.

11. An electronic device, comprising:
a panel;
a backlight module, disposed corresponding to the panel;
a first circuit, coupled to the backlight module and comprising a system circuit module and a backlight timing controlling module; and
a second circuit, coupled between the panel and the first circuit, and comprising a panel timing controlling module,
wherein the backlight timing controlling module receives a first signal transmitted from the system circuit module and provides a backlight controlling signal to the backlight module, and the panel timing controlling module receives a second signal transmitted from the system circuit module and provides a panel controlling signal to the panel.

12. The electronic device according to claim 11, wherein the first circuit is disposed on a circuit board, wherein the system circuit module and the backlight timing controlling module are disposed on different chips.

13. The electronic device according to claim 11, wherein the first circuit is disposed on a circuit board, wherein the system circuit module and the backlight timing controlling module are disposed on a same chip.

14. The electronic device according to claim 11, wherein the backlight module comprises:
at least one light emitting unit;
a backlight data driving circuit; and
a backlight scanning driving circuit, wherein the backlight data driving circuit and the backlight scanning driving circuit drive the at least one light emitting unit according to the backlight controlling signal.

15. The electronic device according to claim 14, wherein the backlight module further comprises:
a backlight controlling circuit, coupled to the backlight timing controlling module, the backlight data driving circuit, and the backlight scanning driving circuit, outputting a backlight data driving signal to the backlight data driving circuit according to the backlight controlling signal, and outputting a backlight scanning driving signal to the backlight scanning driving circuit, wherein the backlight controlling signal comprises a gray scale signal and a scanning signal.

16. The electronic device according to claim 15, wherein the gray scale signal is related to a brightness of the at least one light emitting unit, and the scanning signal is related to a timing of the at least one light emitting unit.

17. The electronic device according to claim 14, further comprising:
a backlight controlling circuit, coupled to the backlight timing controlling module, the backlight data driving circuit, and the backlight scanning driving circuit, wherein the backlight controlling circuit and the first circuit are disposed on a same circuit board.

18. The electronic device according to claim 11, wherein the panel comprises:
at least one display unit;
a panel data driving circuit, coupled to the panel timing controlling module; and
a panel scanning driving circuit, coupled to the panel timing controlling module, wherein the panel data driving circuit and the panel scanning driving circuit drive the at least one display unit according to the panel controlling signal.

19. The electronic device according to claim 18, wherein the panel controlling signal comprises a data driving signal and a scanning driving signal.

20. The electronic device according to claim 19, wherein the panel data driving circuit generates a data signal to be provided to the at least one display unit according to the data driving signal, and the panel scanning driving circuit controls the at least one display unit to receive the data signal according to the scanning driving signal.
